(19) United States
(12) Patent Application Publication
(10) Pub. No.: US 2006/0065527 A1
(43) Pub. Date: Mar. 30, 2006

(54) Polymeric reference electrode

(75) Inventor: Jennifer A. Samproni, San Diego, CA (US)

Correspondence Address: MORGAN LEWIS & BOCKIUS LLP, 1111 PENNSYLVANIA AVENUE NW, WASHINGTON, DC, 20004, US

(73) Assignee: SenDx Medical, Inc.

(21) Appl. No.: 10/949,961

(22) Filed: Sep. 24, 2004

(51) Int. Cl. G01N 27/26

(52) U.S. Cl. 204/435; 204/418

(57) ABSTRACT

The invention is a polymeric reference electrode having properties equal to or superior to prior art electrodes without the presence of a plasticizer and in which such properties are achieved by incorporation in the membrane of a polymer with a sufficiently low glass transition temperature (T_{g}) to mimic the characteristics of a highly plasticized thermoplastic membrane. Preferred polymers are the polyacrylates, preferably with a linear backbone and pendant substituent groups. The membrane may further include lipophilic polymers and lipophilic additives, such as salts. In the reference electrode the membrane is overlaid on an internal electrode comprised of an internal contact optionally coated with an electrolyte and entrapped in a hydrophilic polymer. The polymeric reference electrode is preferably for use in the context of an ion selective electrode assembly.

### FIELD OF THE INVENTION

The present invention relates to a polymeric reference electrode for use in conjunction with an ion selective electrode. More specifically, the invention relates to a polymeric membrane and electrode that comprise the reference electrode.

### BACKGROUND

Ion selective electrodes (ISEs) are widely used to measure the concentration of ions in a variety of biological and non-biological fluids. The ions to be measured are in fluids that vary in their complexity from fluoride in drinking water, a relatively simple solution, to electrolytes in blood, a substantially more complex solution. Frequently in biological solutions, multiple ions are measured in a single sample using sensors that contain multiple ion selective electrodes.

Generally, ion selective electrodes are composed of an ion selective membrane, an internal electrolyte solution, and an internal reference electrode. The internal reference electrode is contained inside an ion selective electrode assembly, and typically consists of a silver/silver chloride electrode in contact with an appropriate solution containing fixed concentrations of chloride and the ion for which the membrane is selective. The ion-selective electrode must be used in conjunction with a reference electrode (i.e. “outer” or “external” reference electrode) to form a complete electrochemical cell. The configuration is commonly denoted as outer reference electrode|test solution|membrane|internal reference electrode or, outer reference electrode|test solution|ion selective electrode. The measured potential differences (ion-selective electrode vs. outer reference electrode potentials) are linearly dependent on the logarithm of the activity of a given ion in solution. The reference electrode maintains a relatively constant potential with respect to the solution under the conditions prevailing in an electrochemical measurement, and further serves to monitor the potential of the working reference electrode.

An example of a conventional reference electrode is silver/silver chloride (Ag/AgCl) single junction reference electrodes such as those often used with pH meters. Such reference electrodes generally consist of a cylindrical glass tube containing an internal electrolyte solution of 4 M solution of potassium chloride (KCl) saturated with AgCl. The lower end of the glass tube is sealed with a porous ceramic frit that allows the slow passage of the internal electrolyte solution and forms a liquid junction with the external test solution. Dipping into the filling solution is a silver wire coated with a layer of silver chloride. The wire is joined to a low-noise cable that connects to the measuring system to allow voltage to be measured across the junction.

More recently, an area of particular interest has been planar miniature reference electrodes for use with electrochemical systems. A polymeric reference electrode provides the benefits of reduced cost, ease of manufacture and microfabrication. Whereas various miniature planar electrochemical sensors have been successfully commercialized, a stable and reliable miniature planar reference electrode has yet to be introduced. The basic structure of a polymeric reference electrode is an inert membrane enclosing a known reference, such as Ag/AgCl. Nolan et. al., Anal. Chem. 1997, (60), 1244-1247, have disclosed a polymeric reference electrode comprising an internal electrolyte covered with a polyurethane or Nafion® membrane. However, the usefulness of the membrane is limited by the long conditioning time required. Yoon et. al., Sensors and Actuators B, (64) 8-14, have described a polymeric reference electrode comprising a hydrophilic polyurethane membrane doped with equimolar concentrations of cationic and anionic lipophilic additives over Ag/AgCl. This liquid junction free reference electrode has the limitation of a long preconditioning time and ion sensitivity. Choi et. al., U.S. Publ. Pat. Appl. 2002/0065332, have disclosed a polymeric reference electrode membrane comprising 1) a porous polymer or a hydrophilic plasticizer and 2) a lipophilic polymer. A highly plasticized thermoplastic membrane has the advantage of a short condition time, however, the limitations of such membrane formulations are that plasticizer leaching may occur, thus changing the characteristics of the membrane. Further, undoped polyvinyl chloride membranes often exhibit sensitivity to ions due to impurities in the polymer. While these teachings demonstrate that reasonable results may be obtained in the construction of a reference electrode using a polymeric membrane, substantial limitations such as long preconditioning time, changes in the membrane due to plasticizer leaching and potential ion interference due to impurities in the membrane still exist.

### SUMMARY OF THE INVENTION

The invention herein is a significant improvement on the prior art electrodes described above. In its principal embodiment, the invention is a polymeric reference electrode which contains a polymeric membrane comprising a polyacrylate backbone and pendant lipophilic plasticizing groups that provide the polymer with a sufficiently low glass transition temperature (T_{g}) to mimic the characteristics of a highly plasticized thermoplastic membrane. It is critical that the T_{g} is below room temperature (25° C.); i.e. that it is flexible at room temperature in the absence of a plasticizing agent. It is preferred that the T_{g} be ≦0° C. and more preferably that it be ≦−10° C. A T_{g} range of −10° C. to −100° C. is preferred, and a range of −10° C. to −60° C. is more preferred. The membrane must behave as if it is plasticized to allow for at least an operable level of ion motility. Otherwise, the impedance of the membrane will be too great and it cannot be used to make electrochemical measurements.

The invention is therefore a polymeric reference electrode with a basic structure comparable to prior art electrodes but in which the previously required plasticizer component has been eliminated from the membrane and has been replaced by a plasticizer-free polymer which has a sufficiently low T_{g} so that performance equal to or superior to the prior art devices is achieved without the detrimental properties that presence of a plasticizer causes.

It is preferred but not required that the polymer have a linear portion and branched portion. The preferred membrane polymers are methacrylic-acrylic copolymers, but any suitable polymer that possesses the requisite T_{g} property and otherwise has the appropriate electrode membrane properties may be used. Additionally, the electrode may contain additional polymers suitable for biosensors such as polyvinyl chloride, polyurethane, or silicone rubber, and lipophilic or hydrophilic additives.

One may characterize a suitable (and preferred) plasticizer-free membrane as one comprising a copolymer of methacrylate monomers with R₁ and R₂ pendant alkyl groups where R₁ is any C₁₋₃ alkyl group and R₂ is any C₄₋₁₂ alkyl group. The use of methacrylate monomers of different pendant alkyl groups allows one to achieve a polymer material with not only a plasticizer-free effect but also a better mechanical strength for a desired T_{g}.

The internal contact may be any suitable contact material including, but not limited to Ag/AgCl. The conductive electrolyte may be any suitable salt such as KCl, sodium formate, sodium chloride or the like. The internal electrolyte may be entrapped in any suitable hydrophilic inert polymer which may be, but is not limited to, hydrophilic polyurethane (PU), polyhexylethylmethacrylate (pHEMA), polyvinyl pyrollidone (PVP), polyvinyl alcohol (PVA) or other hydrophilic polymers.

### BRIEF DESCRIPTION OF THE DRAWINGS

The Figures of the drawings are graphical representations of the data resulting from the various experiments set forth below. In each experiment illustrated, a specific ion or compound in a solution was detected by a sensor which included a reference electrode of the present invention and that detection was compared with the simultaneous detection of the same ion or compound of the same solution by a sensor using a reference electrode of known properties. The Figures show the comparative data and also indicate the ranges of error of the data.

Specifically, the ions or compounds tested for are:

FIGS. 1 and 6: pH

FIG. 2: pCO₂

FIGS. 3 and 7: cNa⁺

FIGS. 4 and 8: cK⁺

FIGS. 5 and 9: cCa⁺⁺

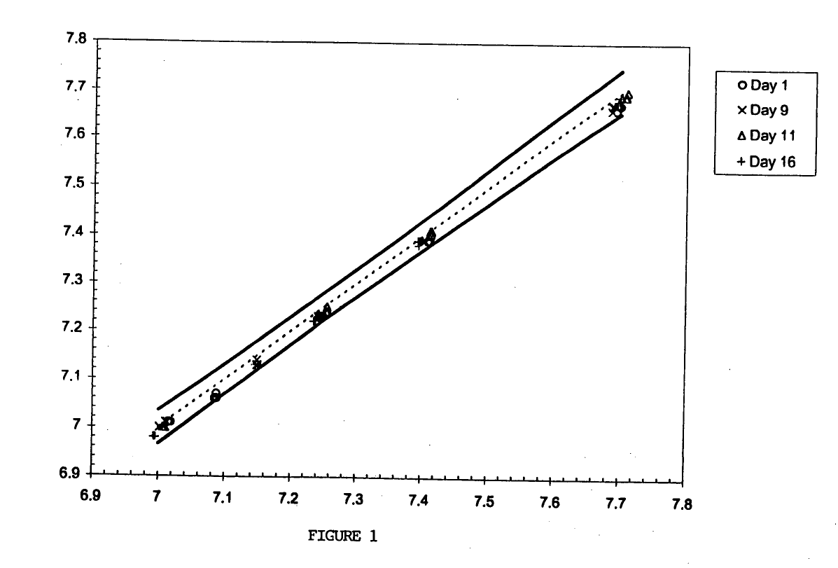

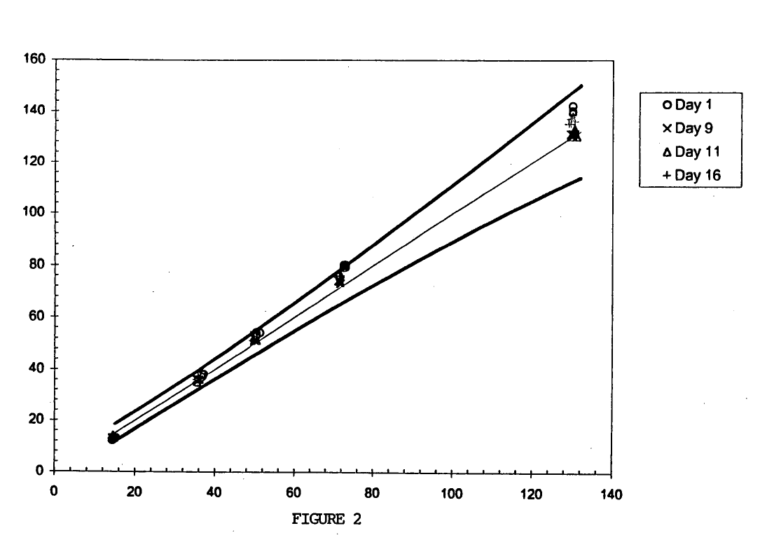

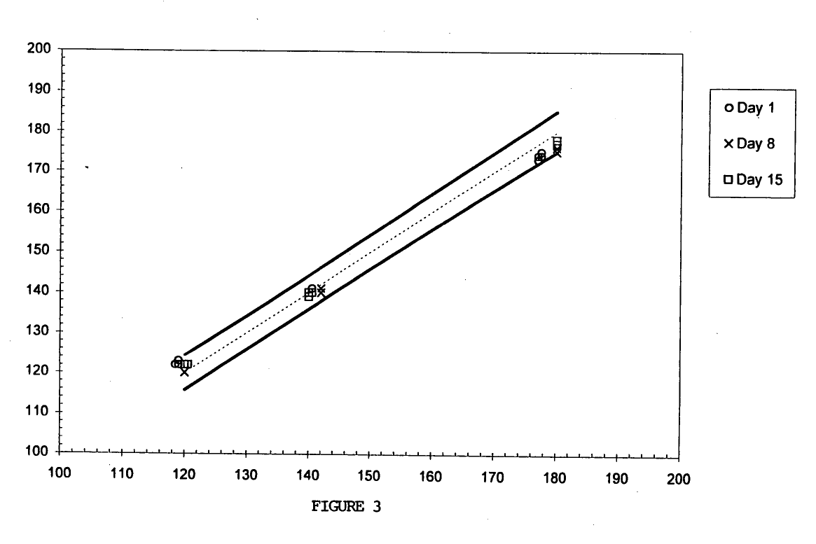

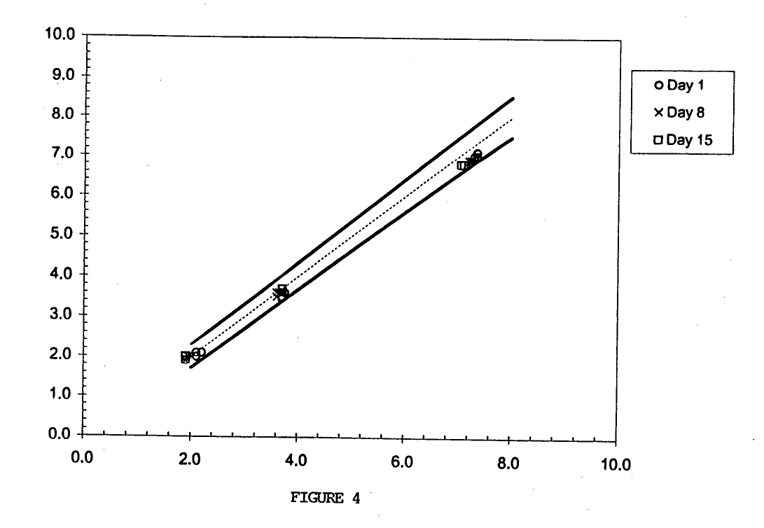

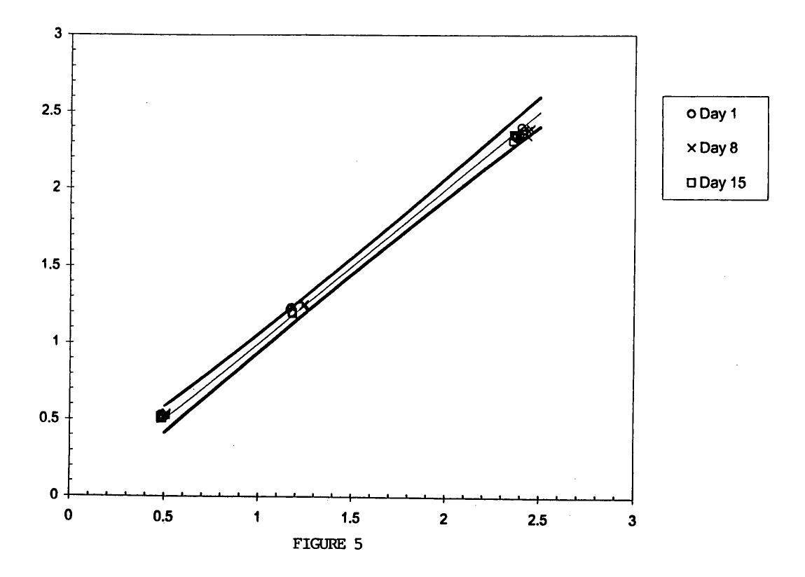

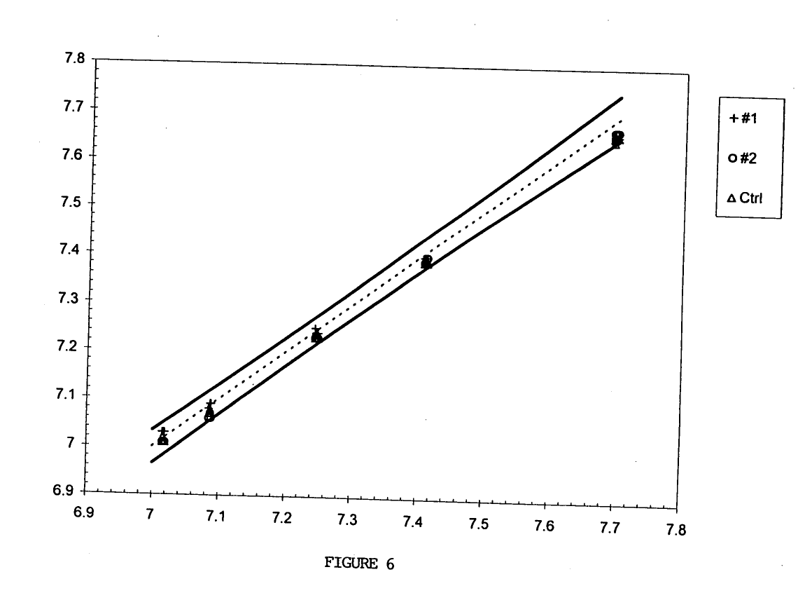

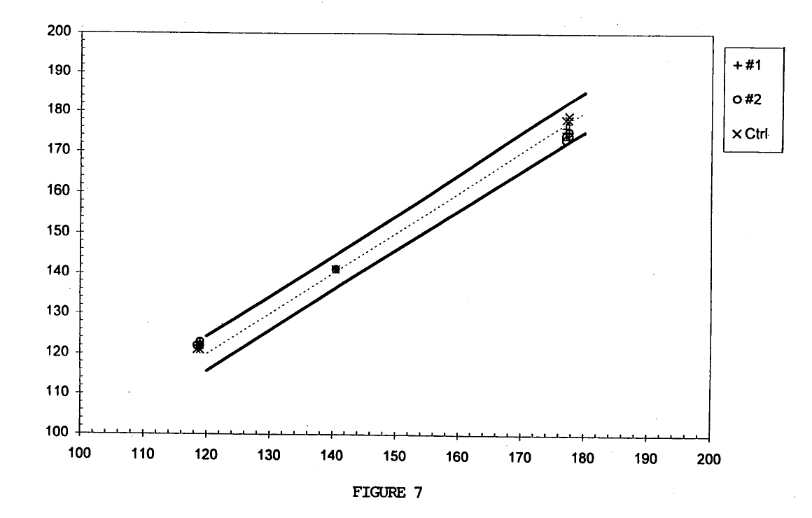

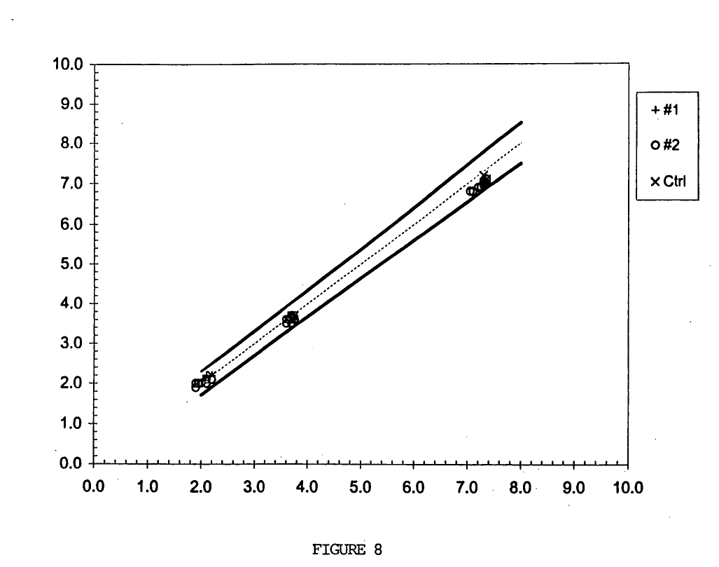

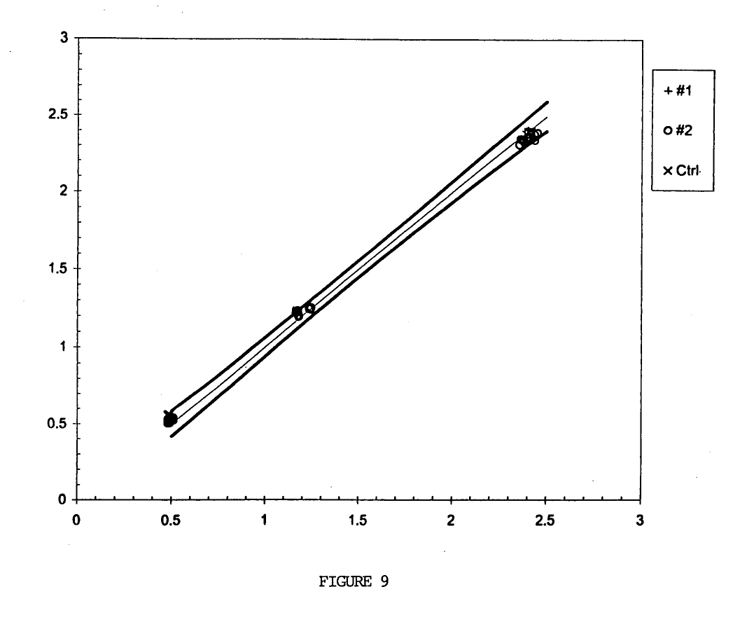

### DETAILED DESCRIPTION AND PREFERRED EMBODIMENTS

The overall nature of the invention will be evident from the following descriptions of the various materials and aspects of the invention.

The membrane is comprised of a polyacrylate backbone and pendant lipophilic plasticizing groups that provide the polymer with a sufficiently low glass transition temperature (T_{g}) to mimic the characteristics of a highly plasticized thermoplastic membrane for use in a polymeric reference electrode. The membrane has a short conditioning time. The membrane does not contain plasticizers which are known to leach out of membranes over time. Additionally, the membrane is quite hydrophobic. This can slow the migration of the internal electrolyte from the reference electrode, and furthermore limit biofouling.

The glass transition temperature (T_{g}) marks the onset of segmental mobility for a polymer. It is the temperature below which the polymer segments do not have sufficient energy to move past one another. Several factors affect the T_{g}. Bond interaction, molecular weight, functionality, branching, and chemical structure all are important in determining T_{g}. Decreased mobility of polymer chains, increased chain rigidity, and a resulting high T_{g} are found where the chains are substituted with several substituents as in PMMA or with bulky substituents as in polystyrene. Polymers with low glass transition temperatures (e.g., T_{g} of −10° C. to −75° C.) are known and commercially available (e.g., from vendors such as Sartomer Co., Exton, Pa.) Such polymers include, but are not limited to, numerous mono- and di-methacrylates. Those skilled in the art will be readily able to select the specific polymers which are best suited for their particular applications, either directly or with the assistance of the vendors.

The T_{g} of the polymer can be measured directly on the polymer using any suitable apparatus. Preferably the polymer T_{g} is in a range from about −10° C. to about −100° C., and a range of −10° C. to about −60° C. is more preferred.

In general the polymer of the invention has an acrylate backbone and is a polymer or copolymer of one or more of the following monomers: methyl methacrylate, methacrylate, ethylacrylate, propylacrylate, butyl acrylate, pentyl acrylate, hexylacrylate and heptylacrylate. Preferred is a methacrylate backbone. The polymer must have a moderately rigid backbone. Depending on the T_{g} required for the specific application, the polymer may be a homopolymer or a copolymer including two or more different monomer units. In a preferred embodiment, the lower alkyl acrylates (C₁ to C₄) are used.

Methods to adjust the T_{g} of polymers are well known to those skilled in the art. Branched chain alkyl acrylates or α- or β-substituted monomers tend to produce a polymer with a higher T_{g} than polymers produced from the corresponding straight chain or non-substituted monomer. Commonly the pendant branch substituents will be C₁-C₁₂ alkyl groups, preferably C₃-C₇ alkyl groups. Additionally, properties of the polymers can be adjusted by including minor amounts of other monomers. Thus, it may be desirable to adjust the hydrophobic/lipophilic balance by including hydroxyl groups such as hydroxymethyl acrylate. The strength and rigidity of the membrane can also be modified by selection of the type (e.g. difunctional vs. polyfunctional) and quantity of cross-linking reagent.

A branched alkyl acrylate monomer is an acrylate monomer wherein the alkyl group is non-linear and non-aromatic. Examples of such compounds include methyl methacrylate and i-butylacrylate. A lower alkyl acrylate monomer is an acrylate monomer wherein the alkyl group is a C₁ to C₄. Examples of such compounds include methacrylate, methyl methacrylate, ethylacrylate, propylacrylate, and butyl acrylate.

There may also present a lipophilic polymer or polymer substituent. The lipophilic component plays an important role in increasing the adhesion and controlling the porosity. The lipophilic polymer is preferably selected from the group consisting of silicone rubber, polyvinyl chloride, polyurethane, polyvinyl chloride carboxylated copolymer or polyvinyl chloride-co-vinyl acetate-co-vinyl alcohol and mixtures thereof. A separate lipophilic component may be present, which lowers the impedance and improves the selectivity over counter ions. Examples of such compounds include the cationic salt potassium tetrakis(4-chlorophenyl)borate (KtpCIPB) and the anionic salt tridodecylmethyl ammonium chloride (TDMAC).

The membrane may be encased in a protective polymeric layer. The protective layer is used to screen out interfering substances or to improve biocompatibility. Examples of such a protective layer include but are not limited to hydrophilic polyurethane and cellulose acetate.

A hygroscopic component readily absorbs moisture from the surrounding environment. Examples of such materials include glycerol and sorbitol. Examples of such polymers include hydrophilic polyurethane (PU), polyhydroxyethylmethacrylate (pHEMA), polyvinylpyrrolidone (PVP) and polyvinyl-acrylate (PVA).

An internal electrical contact is typically a thin, flat piece of an appropriate metal, metal alloy or metal salt, typically silver or silver based, which has a stable electrical potential and that is optionally mounted on an inert support material such as ceramic or glass. The internal contact material may also be formed in openings in ceramic or glass supports for miniaturization of the sensor.

An internal electrode is an internal contact coated with an internal electrolyte on at least one of its flat surfaces, that is optionally encased in a protective layer of a hydrophilic polymer.

An internal electrolyte is a salt, typically KCl or sodium formate, that is applied to at least one flat surface of the internal electrode. Other salts can also be used, as long as they have substantially equitransferent ions, i.e., cation and anion are of similar size. The preference that the ions of the salt be of similar size is so that they have substantially similar mobilities within the membrane of the invention. The electrolyte may be mixed with a hygroscopic element before application to the contact.

The reference electrodes of the present invention are stable in substantially all media of interest.

The membranes used in the reference electrode are made using methods well known to those skilled in the art. The exact method of preparation of the membrane is not a limitation of the instant invention. A suitable membrane is made by thoroughly mixing n-butyl acrylate (nBA) and methyl methacrylate (MMA) preferably in about a 50:50 to 95:5 molar ratio, and more preferably on the order of 80:20. The mixture is aliquotted into vials before polymerization. If the polymerizing agent requiring an initiator is used (e.g. benzoin methyl ether [BME] requires UV light; 2,2′-azobisisobutyronitrile requires heat), the polymerizing agent is added before aliquotting. The mixture is then exposed to the activator, for sufficient time to promote polymerization. Examples of crosslinkers requiring UV initiators include 2,2-dimethoxy-2-phenylacetophenone, benzopheone, bezoyl peroxide and related compounds. Examples of crosslinkers requiring heat as an initiator include benzoyl peroxide and related compounds. If no activation of the polymerizing agent is required, the mixture is aliquotted before addition of the polymerizing agent. The crosslinked polymer is then dissolved using vigorous agitation in an organic solvent, such as cyclohexanone or other organic solvent, to produce a solution of the desired viscosity.

Optionally the polymeric material can be blended with one or more additional polymers such as polyvinylchloride, polyurethane, or polyurethane-silicone at varying ratios. Further, the incorporation of lipophilic additives such as potassium tetrakis(4-chlorophenyl)borate (KtpCIPB) and tridodecylmethylammonium chloride (TDMAC) is possible, preferably at about equimolar concentrations. The membrane is prepared by dispensing multiple layers onto the internal contact, after application of the electrolyte to the internal contact, and allowing the solvent to completely dry between application of each of the layers. The thickness of the membrane can vary, with a preferred thickness of about 3 μm. Such considerations are well known to those skilled in the art.

It is also possible to form the membrane in situ directly on the internal contact to which the electrolyte has been applied. For example, the monomer mixture, optionally in a suitable solvent, can be placed in the desired position and polymerized by directing the initiator (e.g. UV light) to the portions of the polymer to be polymerized. Alternatively the polymer can be polymerized in sheets, cut to the desired size and incorporated into an electrode. It is also possible to apply the polymer by methods such as spin coating, inkjet or screen printing. Polymer ceramic or glass and photopatterning allows for a plurality of different sensors to be incorporated into a single test strip with the polymeric reference electrode of the invention. Such methods are well known to those skilled in the art.

The internal electrode of the invention comprises an internal contact that is preferably Ag/AgCl, but may be composed of other appropriate materials. Such materials are well known to those skilled in the art. An internal electrolyte, such as KCl or sodium formate, is applied to create a submembrane by dispensing a solution of the electrolyte onto the desired portions of the internal contact. The use of other electrolytes is possible; however, it is preferred that the ions are of similar size such that their migration rate through the membrane is similar. Hygroscopic elements such as glycerol and sorbitol may also be added to the solution before dispensing the electrolyte solution. After application of the electrolyte solution, the solvent is allowed to evaporate, leaving the electrolyte on the internal contact. The concentration of the electrolyte solution can vary depending on the electrolyte used. Typically a 1-4 M solution of KCl is used.

To protect and stabilize the electrolyte coated on the internal contact, the internal contact may be entrapped in a protective layer of hydrophilic polyurethane (PU), polyhydroxyethylmethacrylate (pHEMA), polyvinylpyrrollidone (PVP), polyvinylacrylate (PVA) or any other hydrophilic polymer.

The exact size and geometry of the reference electrode is determined by the sensor into which it is incorporated. Such considerations are not a limitation of the instant invention.

### EXAMPLE 1

Preparation of the reference electrode. n-butylacrylate (nBA) and methyl methacrylate (MMA) were combined in an 80:20 molar ratio. Benzoin methyl ether (BME) was added to the solution to a final concentration of 0.5%, and the mixture was stirred rapidly until it was completely dissolved. The solution was then divided into glass scintillation vials with approximately 5 ml of the solution per vial. The vials were then placed under a high intensity UV lamp for about 1 hour until fully polymerized. The polymer was then dissolved in cyclohexanone with vigorous agitation to produce copolymer solution of an appropriate viscosity. The solution was optionally mixed with a solution of PVC before use for coating the submembranes.

The internal electrode was prepared by applying a 1-4 M solution of KCl in PVA to form a submembrane on an Ag/AgCl contact. The aqueous phase was then dried.

The reference electrode was assembled by coating the submembrane with two to three layers of the polymeric membrane of the invention. The electrode was allowed to dry completely between layers.

### EXAMPLE 2

Testing of the polymeric reference electrode. Comparison to Calomel reference electrode. The polymeric reference electrode was compared to a commercially available Calomel reference electrode. The mV differential from the test calibration solution to various other test solutions obtained with the polymeric reference electrode was compared to data obtained with a Calomel reference electrode. The polymeric reference electrode of the instant invention was found to be comparably stable to the Calomel reference electrode based on repeated measurements of the series of test solutions.

### EXAMPLE 3

Testing of the Polymeric Reference Electrode. Practical application of the reference electrode. Polymeric reference electrodes were used in conjunction with ion selective electrodes (ISEs) to measure the concentration of various analytes in whole blood and aqueous solutions. The sensors were exposed to extensive testing over several months. The results of the ISEs that were referenced off of the polymeric reference electrode tracked well with the control ISEs that were referenced off of the standard gel electrode. This was true for each of the ions tested; Na⁺, Ca⁺⁺, K⁺ and H⁺ (pH). The polymeric reference electrode of the invention was found to produce stable, reproducible results over a range of concentrations of each of the ions within two standard deviations of the average value determined using a National Institute of Standards and Technology (NIST) traceable standard reference method.

Although exemplary embodiments of the invention have been described above by way of example only, it will be understood by those skilled in the field that modifications and variations may be made to the disclosed embodiments without departing from the scope and spirit of the invention, which is to be defined solely by the appended claims.

I claim:

1-28. (canceled)

29. A polymeric reference electrode comprising:
an internal electrode comprising a contact having a stable electrical potential and a membrane comprising a polymer with a glass transition temperature (Tg) of less than about 25° C.

30. The polymeric reference electrode according to claim 29, wherein the polymer comprises lipophilic plasticizing groups pendant from a polymeric backbone.

31. The polymeric reference electrode according to claim 30, wherein the lipophilic plasticizing groups are selected from C₁ to C₁₂ alkyl groups.

32. The polymeric reference electrode according to claim 31, wherein the lipophilic plasticizing groups are selected from C₃ to C₇ alkyl groups.

33. The polymeric reference electrode according to claim 30, wherein the polymeric backbone comprises a polyacrylate.

34. The polymeric reference electrode according to claim 33, wherein the polyacrylate comprises a homopolymer of a monomer from the group consisting of methacrylate, methyl methacrylate, ethyl acrylate, propyl acrylate, butyl acrylate, pentyl acrylate, hexyl acrylate and heptyl acrylate.

35. The polymeric reference electrode according to claim 33, wherein the polyacrylate comprises a copolymer of at least two monomers selected from the group consisting of methacrylate, methyl methacrylate, ethyl acrylate, propyl acrylate, butyl acrylate, i-butyl acrylate, pentyl acrylate, hexyl acrylate and heptyl acrylate.

36. The polymeric reference electrode according to claim 35, wherein the polyacrylate is a copolymer of butyl acrylate and methyl methacrylate.

37. The polymeric reference electrode according to claim 36, wherein the molar ratio of the butyl acrylate to the methyl methacrylate is in a range of about 50:50 to about 95:5.

38. The polymeric reference electrode according to claim 37, wherein the molar ratio of the butyl acrylate to the methyl methacrylate is about 80:20.

39. The polymeric reference electrode according to claim 29, wherein the membrane further comprises at least one additional polymer.

40. The polymeric reference electrode according to claim 39, wherein the at least one additional polymer is selected from the group consisting of silicone rubber, polyvinyl chloride (PVC), polyurethane, polyvinylchloride carboxylated copolymer, polyvinyl chloride-co-vinyl acetate-co-vinyl alcohol and combinations thereof.

41. The polymeric reference electrode according to claim 29, wherein the membrane further comprises at least one lipophilic additive which lowers the impedance of the membrane and improves the selectivity over cationic and anionic counter ions.

42. The polymeric reference electrode according to claim 29, wherein the contact of the internal electrode comprises a metal, a metal alloy, a metal salt or a combination thereof.

43. The polymeric reference electrode according to claim 42, wherein the contact comprises silver/silver chloride.

44. The polymeric reference electrode according to claim 29, further comprising an internal electrolyte.

45. The polymeric reference electrode according to claim 44, wherein the internal electrolyte coats at least a portion of the contact.

46. The polymeric reference electrode according to claim 44, wherein the membrane is doped with the internal electrolyte.

47. The polymeric reference electrode according to claim 44, wherein the internal electrolyte comprises a salt, wherein the cationic and anionic components of the salt are of similar size.

48. The polymeric reference electrode according to claim 44, wherein the internal electrolyte further comprises at least one hygroscopic compound.

49. The polymeric reference electrode according to claim 29, wherein the membrane is covered by at least one polymeric layer.

50. The polymeric reference electrode according to claim 49, wherein the at least one polymeric layer is selected from the group consisting of hydrophilic polyurethane (PU) and cellulose acetate.

51. The polymeric reference electrode according to claim 44, wherein the internal electrolyte is entrapped in at least one polymeric layer.

52. The polymeric reference electrode according to claim 51, wherein the at least one polymeric layer is selected from the group consisting of polyhydroxyethylmethacrylate (pHEMA), polyvinylpyrrollidone (PVP) and polyvinylacrylate (PVA).

53. The polymeric reference electrode according to claim 29, wherein the Tg of the polymer is less than about 0° C.

54. The polymeric reference electrode according to claim 53, wherein the Tg of the polymer is between about −10° C. and about −100° C.

55. A membrane for use in a polymeric reference electrode comprising a polymer with a glass transition temperature (Tg) of less than about 25° C.

56. The membrane according to claim 55, wherein the polymer comprises lipophilic plasticizing groups pendant from a polymeric backbone.

57. The membrane according to claim 56, wherein the lipophilic plasticizing groups are selected from C₁ to C₁₂ alkyl groups.

58. The membrane according to claim 57, wherein the lipophilic plasticizing groups are selected from C₃ to C₇ alkyl groups.

59. The membrane according to claim 56, wherein the polymeric backbone comprises a polyacrylate.

60. The membrane according to claim 59, wherein the polyacrylate comprises a homopolymer of a monomer from the group consisting of methacrylate, methyl methacrylate, ethyl acrylate, propyl acrylate, butyl acrylate, pentyl acrylate, hexyl acrylate and heptyl acrylate.

61. The membrane according to claim 59, wherein the polyacrylate comprises a copolymer of at least two monomers selected from the group consisting of methacrylate, methyl methacrylate, ethyl acrylate, propyl acrylate, butyl acrylate, i-butyl acrylate, pentyl acrylate, hexyl acrylate and heptyl acrylate.

62. The membrane according to claim 61, wherein the polyacrylate is a copolymer of butyl acrylate and methyl methacrylate.

63. The membrane according to claim 62, wherein the molar ratio of the butyl acrylate to the methyl methacrylate is in a range of about 50:50 to about 95:5.

64. The membrane according to claim 63, wherein the molar ratio of the butyl acrylate to the methyl methacrylate is about 80:20.

65. The membrane according to claim 55, further comprising at least one additional polymer.

66. The membrane according to claim 65, wherein the at least one additional polymer is selected from the group consisting of silicone rubber, polyvinyl chloride (PVC), polyurethane, polyvinylchloride carboxylated copolymer, polyvinyl chloride-co-vinyl acetate-co-vinyl alcohol and combinations thereof.

67. The membrane according to claim 55, wherein the membrane further comprises at least one lipophilic additive which lowers the impedance of the membrane and improves the selectivity over cationic and anionic counter ions.

68. The membrane according to claim 55, wherein the membrane is doped with an internal electrolyte.

69. The membrane according to claim 68, wherein the internal electrolyte comprises a salt, wherein the cationic and anionic components of the salt are of similar size.

70. The membrane according to claim 68, wherein the internal electrolyte further comprises at least one hygroscopic compound.

71. The membrane according to claim 55, wherein the membrane is covered by at least one polymeric layer.

72. The membrane according to claim 71, wherein the at least one polymeric layer is selected from the group consisting of hydrophilic polyurethane (PU) and cellulose acetate.

73. The membrane according to claim 68, wherein the internal electrolyte is entrapped in at least one polymeric layer.

74. The membrane according to claim 73, wherein the at least one polymeric layer is selected from the group consisting of polyhydroxyethylmethacrylate (pHEMA), polyvinylpyrrollidone (PVP) and polyvinylacrylate (PVA).

75. The membrane according to claim 55, wherein the Tg of the polymer is less than about 0° C.

76. The membrane according to claim 75, wherein the Tg of the polymer is between about −10° C. and about −100° C.
